(19) United States
(12) Patent Application Publication
(10) Pub. No.: US 2011/0102763 A1
(43) Pub. Date: May 5, 2011

(54) Three Dimensional Imaging Device, System and Method

(75) Inventors: Margaret K. Brown, Seattle, WA (US); Sridhar Madhavan, Redmond, WA (US)

(73) Assignee: MICROVISION, INC., Redmond, WA (US)

(21) Appl. No.: 12/609,387

(22) Filed: Oct. 30, 2009

(51) Int. Cl. G01C 3/08

(52) U.S. Cl. 356/4.01

(57) ABSTRACT

A 3D imaging system projects a light spot on an object and images the light spot with a 2D image sensor. The position of the light spot within the field of view of the 2D image sensor is used to determine the distance to the object.

### FIELD

The present invention relates generally to imaging devices, and more specifically to three dimensional imaging devices.

### BACKGROUND

Three dimensional (3D) data acquisition systems are increasingly being used for a broad range of applications ranging from the manufacturing and gaming industries to surveillance and consumer displays.

Some currently available 3D data acquisition systems use a “time-of-flight” camera that measures the time it takes for a light pulse to travel round-trip from a light source to an object and then back to a receiver. These systems typically operate over ranges of a few meters to several tens of meters. The resolution of these systems decreases at short distances, making 3D imaging within a distance of about one meter impractical.

### BRIEF DESCRIPTION OF THE DRAWINGS

FIG. 1 shows a 3D imaging device with accordance with various embodiments of the present invention;

FIG. 2 shows a projection surface with time-multiplexed light spots;

FIG. 3 shows multiple projection surfaces with time-multiplexed light spots;

FIG. 4 shows the determination of distance as a function of detected light position in a 2D image sensor;

FIG. 5 shows a flowchart in accordance with various embodiments of the present invention;

FIGS. 6 and 7 show modified light spot sequences to focus on a region of interest;

FIG. 8 shows timing of light spot sequences in accordance with various embodiments of the present invention;

FIG. 9 shows a 3D imaging device in accordance with various embodiments of the present invention;

FIG. 10 shows a flowchart in accordance with various embodiments of the present invention;

FIG. 11 shows a mobile device in accordance with various embodiments of the present invention;

FIGS. 12 and 13 show robotic vision systems in accordance with various embodiments of the invention;

FIG. 14 shows a wearable 3D imaging system in accordance with various embodiments of the invention;

FIG. 15 shows a cane with a 3D imaging system in accordance with various embodiments of the invention; and

FIGS. 16 and 17 show medical systems with 3D imaging devices in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

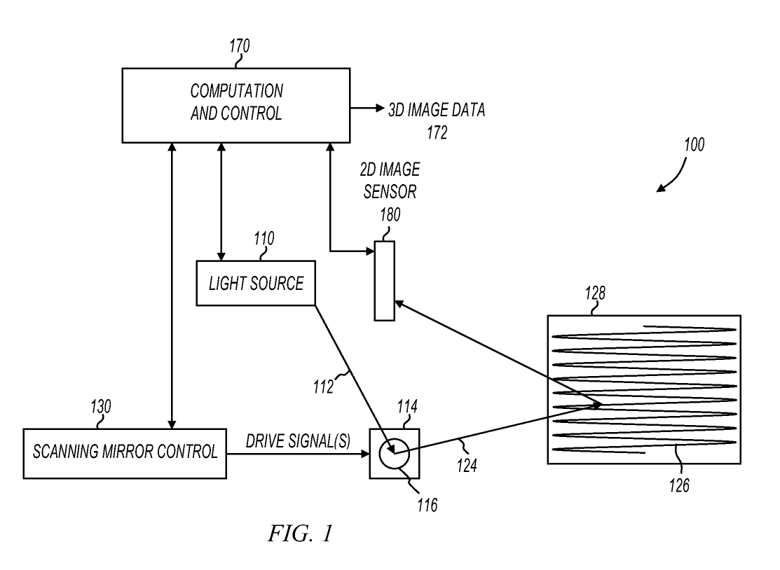

FIG. 1 shows a 3D imaging device in accordance with various embodiments of the present invention. As shown in FIG. 1, 3D imaging device 100 includes a light source 110, which may be a laser light source such as a laser diode or the like, capable of emitting a beam 112 which may be a laser beam. The beam 112 impinges on a scanning platform 114 which is part of a microelectromechanical system (MEMS) based scanner or the like, and reflects off of scanning mirror 116 to generate a controlled output beam 124. A scanning mirror control circuit 130 provides one or more drive signal(s) to control the angular motion of scanning mirror 116 to cause output beam 124 to generate a raster scan 126 on a projection surface 128.

In some embodiments, raster scan 126 is formed by combining a sinusoidal component on the horizontal axis and a sawtooth component on the vertical axis. In these embodiments, controlled output beam 124 sweeps back and forth left-to-right in a sinusoidal pattern, and sweeps vertically (top-to-bottom) in a sawtooth pattern with the display blanked during flyback (bottom-to-top). FIG. 1 shows the sinusoidal pattern as the beam sweeps vertically top-to-bottom, but does not show the flyback from bottom-to-top. In other embodiments, the vertical sweep is controlled with a triangular wave such that there is no flyback. In still further embodiments, the vertical sweep is sinusoidal. The various embodiments of the invention are not limited by the waveforms used to control the vertical and horizontal sweep or the resulting raster pattern.

3D imaging device 100 also includes computation and control component 170 and 2D image sensor 180. In some embodiments, 2D image sensor 180 is a light detection device that includes an array of photosensitive elements that detect either or both of visible and nonvisible light. For example, 2D image sensor 180 may be a charge coupled device (CCD) or a CMOS image sensor.

In operation, light source 110 produces light pulses and scanning mirror 116 reflects the light pulses as beam 124 traverses raster pattern 126. This results in a series of time-multiplexed light spots on projection surface 128 along raster pattern 126. 2D image sensor 180 captures images of the light spots created as the light pulses hit projection surface 128. Computation and control component 170 produces 3D image data 172 using knowledge of the scanning mirror position, the timing of the light pulses produced by light source 110, and the images captured by 2D image sensor 180. The 3D image data 172 represents the distance from the scanning mirror 116 to each of the light spots. When a three dimensional object is placed in front of projection surface 128, the 3D image data 172 represents the surface contour of the object.

Scanning mirror 116 and 2D image sensor 180 are displaced laterally so as to provide parallax in the field of view of 2D image sensor 180. Because of the parallax, a difference in distance between 2D image sensor 180 and a light spot is manifested as a change in the position of the light spot within 2D image sensor 180. Triangulation computations are performed for each detected light spot (or for the centroid of adjacent light spots) to determine the underlying topography of the object. Parallax and triangulation are discussed further below with reference to later figures.

Computation and control component 170 may influence the operation of light source 110 and scanning mirror control circuit 130 or may receive information regarding their operation. For example, in some embodiments, computation and control component 170 may control the timing of light pulses produced by light source 110 as well as the timing of the raster pattern. In other embodiments, other circuits (not shown) control the timing of the light pulses and the raster pattern, and computation and control component 170 is provided this timing information.

Computation and control component 170 may be implemented in hardware, software, or in any combination. For example, in some embodiments, computation and control component is implemented in an application specific integrated circuit (ASIC). Further, in some embodiments, some of the faster data acquisition is performed in an ASIC and overall control is software programmable.

In some embodiments, computation and control component 170 includes a phase lock loop (PLL) to phase lock the timing of light spots and 2D image capture. For example, component 170 may command 2D image sensor 180 to provide a frame dump after each light spot. The frame dump may include any number of bits per pixel. For example, in some embodiments, 2D image sensor 180 captures one bit per pixel, effectively thresholding the existence or nonexistence of a light spot at a given pixel location. In other embodiments, 2D image sensor 180 captures two or three bits per pixel. This provides a slight increase in resolution, while still providing the advantage of reduced computational complexity. In still further embodiments, 2D image sensor 180 captures many more bits per pixel.

In some embodiments, light source 110 sources nonvisible light such as infrared light. In these embodiments, image sensor 180 is able to detect the same nonvisible light. For example, in some embodiments, light source 110 may be an infrared laser diode that produces light with a wavelength of substantially 808 nanometers (nm). In other embodiments, light source 110 sources visible light such as blue light. In these embodiments, image sensor 180 is able to detect the same visible light. For example, in some embodiments, light source 110 may be a blue laser diode that produces light with a wavelength of substantially 405 nanometers (nm). The wavelength of light is not a limitation of the present invention. Any wavelength, visible or nonvisible, may be used without departing from the scope of the present invention.

In some embodiments, image sensor 180 is able to detect both visible and nonvisible light. For example, light source 110 may source nonvisible light pulses, while image sensor 180 detects both the nonvisible light pulses and visible light. In these embodiments, the 3D image data 172 may include color and depth information for each pixel. An example might be the fourtuple (Red, Green, Blue, Distance) for each pixel.

In some embodiments, mirror 116 scans in one dimension instead of two dimensions. This results in a raster pattern that scans back and forth on the same horizontal line. These embodiments can produce a 3D profile of an object where the horizontal line intersects the object.

Many applications are contemplated for 3D imaging device 100. For example, 3D imaging device 100 may be used in a broad range of industrial robotic applications. For use in these applications, an infrared scanning embodiment may be used to rapidly gather 2D and 3D information within the proximity of the robotic arm. Based on image recognition and distance measurements the robot is able to navigate to a desired position and or object and then to manipulate and move that object. Also for example, 3D imaging device 100 may be used in gaming applications, such as in a game console or handheld controller. Still further examples include applications in surveillance and consumer displays.

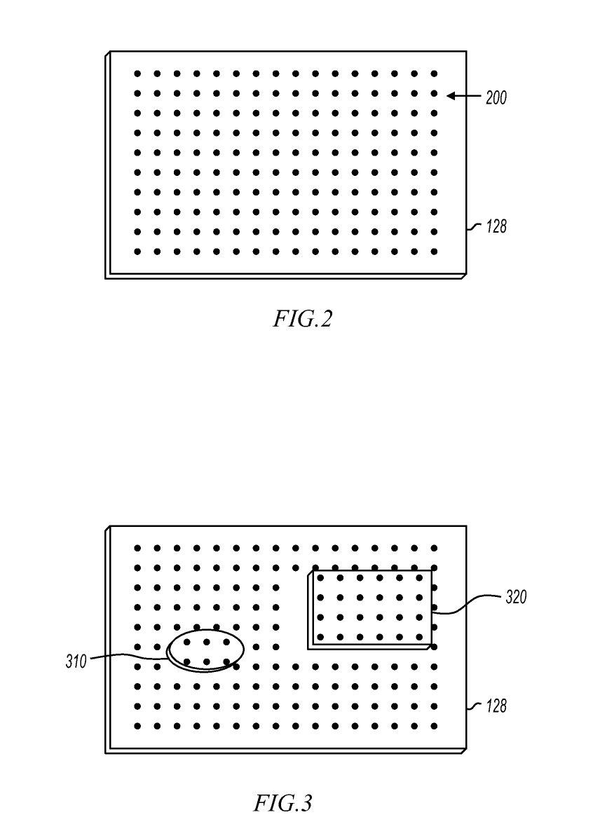

FIG. 2 shows a projection surface with time-multiplexed light spots. The spots are shown in a regular grid, but this is not a limitation. As discussed above with reference to FIG. 1, the light spots will be present at points within the raster pattern of the scanned beam. Light spots 200 are illuminated at different times as the beam sweeps over the raster pattern. At any given time, either one or no light spots will be present on projection surface 128. A light spot may include a single pixel or a series of pixels.

Light spots 200 are shown across the entire raster pattern, but this is not a limitation of the present invention. For example, in some embodiments, only a portion of the raster pattern is illuminated with light spots for 3D imaging. In yet further embodiments, a region of interest is selected based on previous 3D imaging or other image processing, and light spots are only projected into the region of interest. As described below with reference to later figures, the region of interest may be adaptively modified.

In the example of FIG. 2, projection surface 128 is flat, and all of light spots 200 are in the same plane. Accordingly, light spots 200 appear uniform across the surface. Projection surface 128 is shown in the manner that it would be viewed by a 2D image sensor. The view is from the lower left causing parallax, but it is not apparent because of the uniform surface.

FIG. 3 shows multiple projection surfaces with time-multiplexed light spots. FIG. 3 shows the same projection surface 128 and the same light spots 200. FIG. 3 also shows two additional projection surfaces that are at fixed distances in front of surface 128. In the example of FIG. 3, surface 310 is closer to projection surface 128 than surface 320.

The light spots that are incident on surfaces 310 and 320 appear offset up and to the right because of the parallax in the view of the 2D image sensor. The light spots that are incident on surface 320 are offset further than the light spots incident on surface 310 because surface 320 is further away from projection surface 128. Various embodiments of the present invention determine the distance to each light spot by measuring the amount of offset in the 2D image and then performing triangulation.

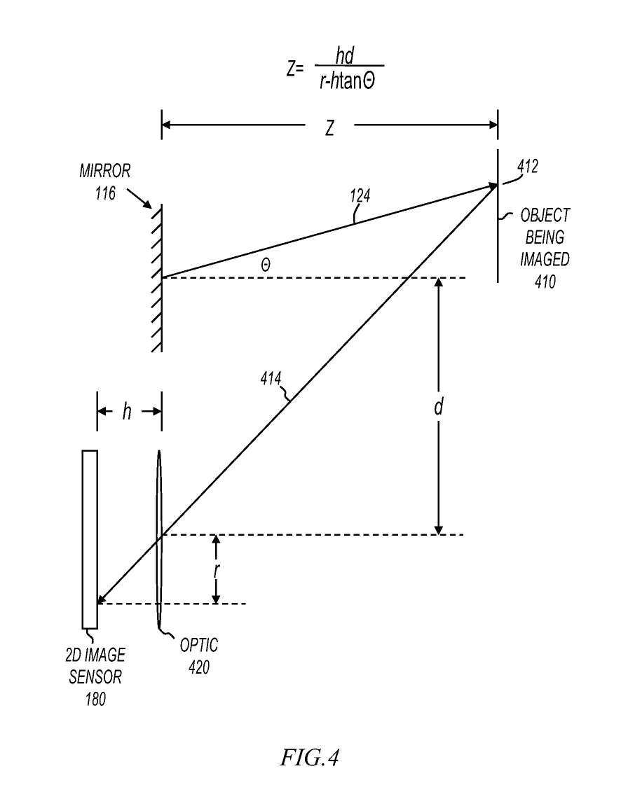

FIG. 4 shows the determination of distance as a function of detected light position in a 2D image sensor. FIG. 4 shows mirror 116, 2D image sensor 180, optic 420, and object being imaged 410. In operation, beam 124 reflects off of mirror 116. The light source is not shown. Beam 124 creates a light spot on the object being imaged at 412. Ray 414 shows the path of light from light spot 412 through optic 420 to 2D image sensor 180.

Using triangulation, the distance from the plane of the mirror to the light spot (z) is determined as:

$$z = \frac{hd}{r - h tan Θ} \qquad ( 1 )$$

where:

d is the offset distance between the mirror and the optic;

Θ is the beam angle;

h is the distance between the optic and the image sensor; and

r is the offset of the light spot within the field of view of the image sensor.

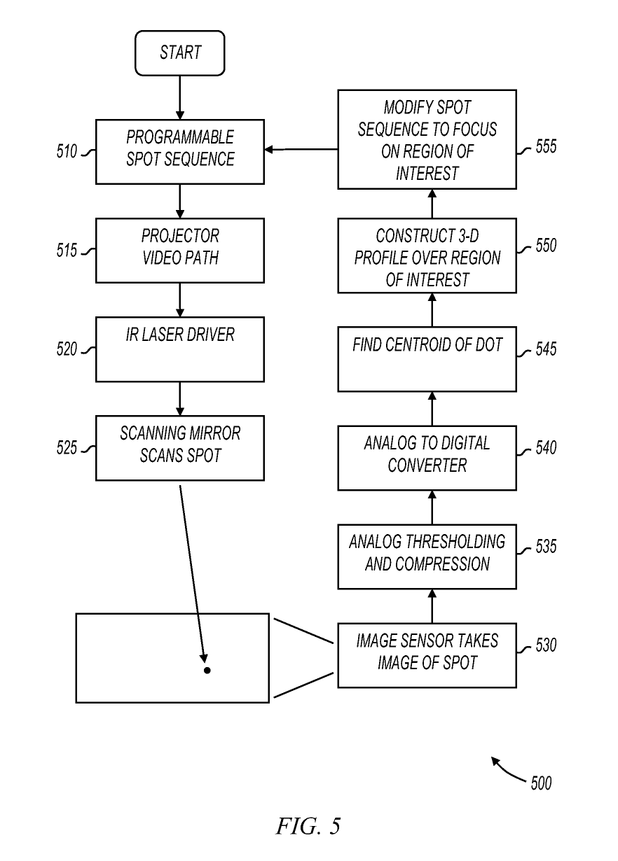

FIG. 5 shows a flowchart in accordance with various embodiments of the present invention. In some embodiments, method 500, or portions thereof, is performed by a 3D imaging device, embodiments of which are shown in previous figures. In other embodiments, method 500 is performed by a series of circuits or an electronic system. Method 500 is not limited by the particular type of apparatus performing the method. The various actions in method 500 may be performed in the order presented, or may be performed in a different order. Further, in some embodiments, some actions listed in FIG. 5 are omitted from method 500.

Method 500 is shown beginning with block 510 in which a programmable light spot sequence is generated. The programmable spot sequence may be any size with any spacing. For example, in some embodiments, the programmable light spot sequence may be specified by a programmable radius and spot spacing. In addition, spots within the spot sequence can be any size. The size of a spot can be modified by illuminating adjacent pixels or driving a laser for more than one pixel time.

At 515, the programmable spot sequence is processed by a video path in a scanning laser projector. At 520, an infrared laser driver is turned on at times necessary to illuminate each of the light spots in the programmable sequence. In some embodiments, the infrared laser is turned on for one pixel time for each spot. In these embodiments, the light spots are the size of one pixel. In other embodiments, the infrared laser is turned on repeatedly for a number of adjacent pixels, forming a light spot that is larger than one pixel. In still further embodiments, the infrared laser is turned on and left on for more than one pixel time. In these embodiments, the light spot takes the form of a line, the length of which is a function of the laser “on” time. At 525, the scanning mirror reflects the infrared light to create the light spots on an object being imaged.

At 530, a 2D image sensor takes an image of a light spot. The image capture process is phase locked to the scanning of each light spot such that each image captures only a single light spot across the entire 2D array. At 535, the 2D array thresholds each pixel. If the amplitude of the pixel does not exceed a specified threshold, an analog-to-digital converter (540) delivers a single bit word equal to zero. Otherwise, the converter delivers a single bit word equal to one. This enables kHz speeds in the transferring of data to the digital domain.

At 545, image processing is performed on the image to determine the centroid location of the light spot. In some embodiments, parallel processing provides high speed data reduction. At 550, a 3D profile is constructed using triangulation as described above with reference to FIG. 4. At 555, the programmable light spot sequence is modified to focus on a region of interest and this programmable light spot sequence is used to perform further 3D imaging.

In some embodiments, a lookup table is populated with depth values as a function of beam angle (Θ) and centroid of light spot (r). For example, the 3D profile at 550 may be generated by interpolating into a lookup table that has been calibrated using triangulation.

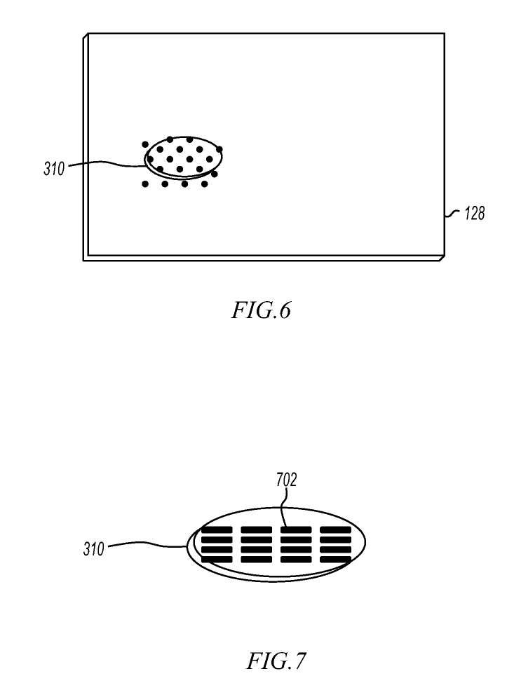

FIG. 6 shows a modified light spot sequence to focus on a region of interest. Projection surfaces 128 and 310 are shown in FIG. 6. The light spot sequence in FIG. 6 is concentrated on projection surface 310. This may occur through method 500 (FIG. 5) where initially the programmable light spot sequence covers the entire field of view (see FIG. 3). Projection surface 310 is identified as a region of interest, and the programmable light spot sequence is modified to focus on projection surface 310. Note that the light spot spacing has been decreased in FIG. 6. This allows more spatial resolution when 3D imaging in the region of interest.

FIG. 7 shows a modified light spot sequence to focus on a region of interest. Projection surface 310 is shown with light spots 702. Light spots 702 differ in shape from light spots shown in FIG. 6. Light spots 702 are an example of light spots created by illuminating adjacent pixels or sweeping the laser beam during periods that the laser is left on. Each of light spots 702 is displayed over a finite time period. For example, in some embodiments, adjacent pixels are illuminated in a time-multiplexed manner, and in other embodiments, a continuous line is formed when a beam is swept across the light spot.

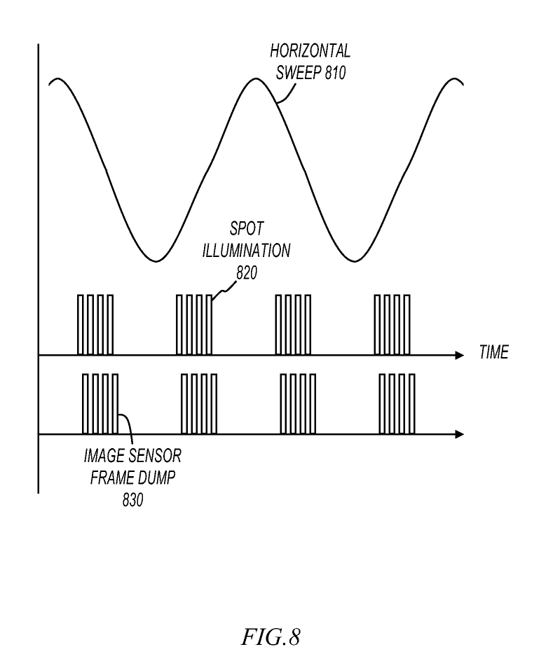

FIG. 8 shows timing of light spot sequences in accordance with various embodiments of the present invention. FIG. 8 shows horizontal sweep waveform 810, spot illumination times 820 and image sensor frame dump times 830. The timing illustrated in FIG. 8 may result in the light spot sequence of FIG. 7. For example, during each horizontal sweep, four spot illuminations 820 are present. Each sweep produces four light spots shown in the horizontal dimension in FIG. 7, and the number of successive sweeps determines the number of light spots shown in the vertical dimension in FIG. 7. In this example, there are four light spots in the vertical dimension.

The time duration of each spot illumination 820 determines the width of each light spot 702 (FIG. 7). In some embodiments, each spot illumination 820 is a series of adjacent pixels that illuminated, and in other embodiments, each spot illumination 820 is a result of a continuous “on” period for the laser.

In some embodiments, the frame dump of the 2D image sensor is phase locked to the video path. For example, image sensor frame dumps 830 may be timed to occur after each spot illumination 820. In these embodiments, a 2D image sensor will capture separate images of each light spot. The centroid of each light spot may be found by integrating the captured light intensity over the light spot location. In addition, centroids of vertically adjacent light spots may be accumulated.

In some embodiments, the light intensity is captured as a single bit value for each pixel. This reduces the computational complexity associated with finding the centroid. In other embodiments, the light intensity is captured as more than one bit per pixel, but still a small number. For example, each pixel may be represented by two or three bits. In still further embodiments, each pixel may be represented by many bits of information (e.g., eight or ten bits per pixel).

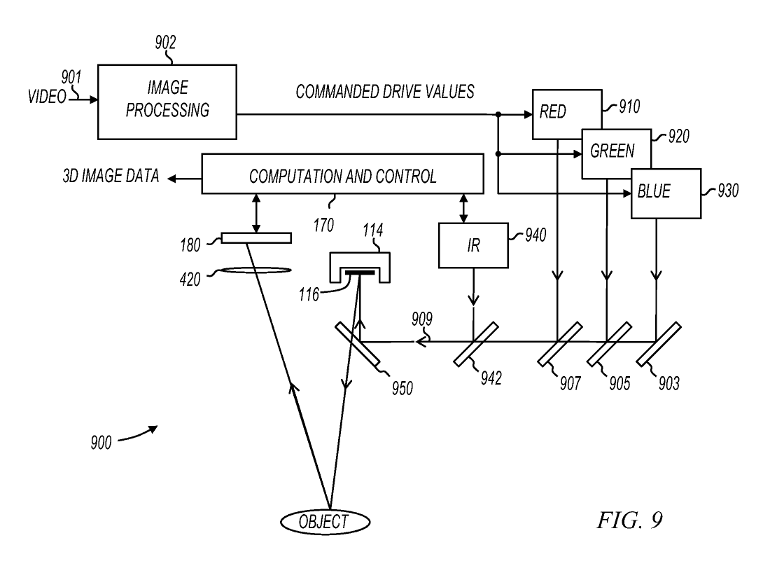

FIG. 9 shows a 3D imaging device in accordance with various embodiments of the present invention. 3D imaging device 900 combines a projector with 3D imaging capabilities. The system receives and displays video content in red, green, and blue, and uses infrared light for 3D imaging.

3D imaging device 900 includes image processing component 902, red laser module 910, green laser module 920, blue laser module 930, and infrared laser module 940. Light from the laser modules is combined with mirrors 903, 905, 907, and 942. 3D imaging device 900 also includes fold mirror 950, scanning platform 114 with scanning mirror 116, optic 420, 2D imaging device 180, and computation and control circuit 170.

In operation, image processing component 902 processes video content at 901 using two dimensional interpolation algorithms to determine the appropriate spatial image content for each scan position. This content is then mapped to a commanded current for each of the red, green, and blue laser sources such that the output intensity from the lasers is consistent with the input image content. In some embodiments, this process occurs at output pixel speeds in excess of 150 MHz.

The laser beams are then directed onto an ultra-high speed gimbal mounted 2 dimensional bi-axial laser scanning mirror 116. In some embodiments, this bi-axial scanning mirror is fabricated from silicon using MEMS processes. The vertical axis of rotation is operated quasi-statically and creates a vertical sawtooth raster trajectory. The horizontal axis is operated on a resonant vibrational mode of the scanning mirror. In some embodiments, the MEMS device uses electromagnetic actuation, achieved using a miniature assembly containing the MEMS die, small subassemblies of permanent magnets and an electrical interface, although the various embodiments are not limited in this respect. For example, some embodiments employ electrostatic actuation. Any type of mirror actuation may be employed without departing from the scope of the present invention.

Embodiments represented by FIG. 9 combine the video projection described in the previous paragraph with IR laser module 940, optic 420, high speed 2D image sensor 180, and computation and control component 170 for 3D imaging of the projection surface. The IR laser and image sensor may be used to invisibly probe the environment with programmable spatial and temporal content at line rates related to the scan frequency of mirror 116. In some embodiments this may be in excess of 54 kHz (scanning both directions at 27 kHz). Computation and control component 170 receives the output of 2D image sensor and produces 3D image data as described above with reference to previous figures. These images can be downloaded at kHz rates. Processing of these images provides ultra-high speed 3D depth information. For example, the entire field of view may be surveyed in 3D within a single video frame, which in some embodiments may be within 1/60th of a second. In this way a very high speed 3D camera results that exceeds the speed of currently available 3D imaging devices by an order of magnitude.

Many applications are contemplated for 3D imaging device 900. For example, the scanned infrared beam may be used to probe the projection display field for hand gestures. These gestures are then used to interact with the computer that controls the display. Applications such as 2D and 3D touch screen technologies are supported. In some embodiments, the 3D imaging is used to determine the topography of the projection surface, and image processing component 902 pre-distorts the video image to provide a non-distorted displayed image on nonuniform projection surfaces.

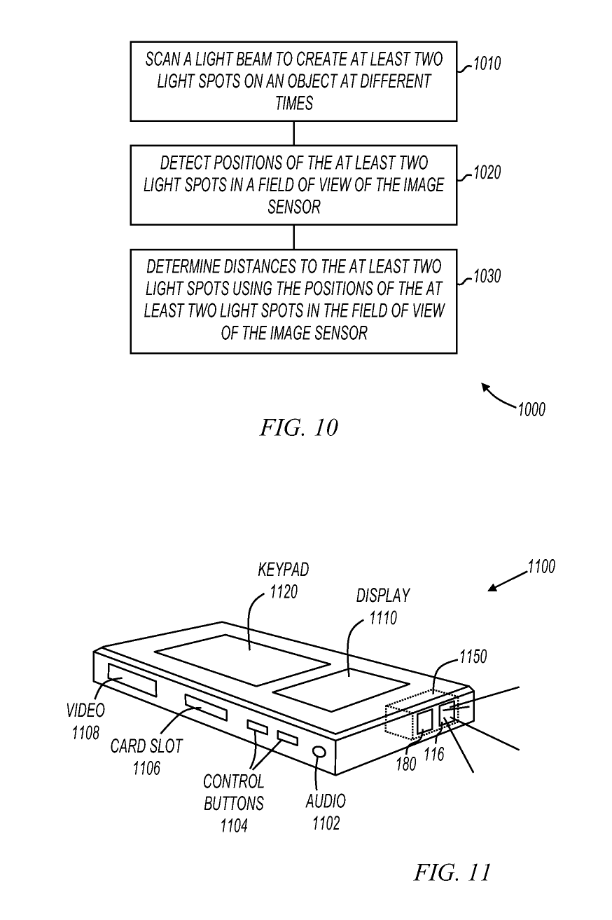

FIG. 10 shows a flowchart in accordance with various embodiments of the present invention. In some embodiments, method 1000, or portions thereof, is performed by a 3D imaging device, embodiments of which are shown in previous figures. In other embodiments, method 1000 is performed by an integrated circuit or an electronic system. Method 1000 is not limited by the particular type of apparatus performing the method. The various actions in method 1000 may be performed in the order presented, or may be performed in a different order. Further, in some embodiments, some actions listed in FIG. 10 are omitted from method 1000.

Method 1000 is shown beginning with block 1010 in which a light beam is scanned to create at least two light spots on an object at different times. Each of the light spots may correspond to any number of pixels. For example, in some embodiments, each light spot is formed using one pixel. Also for example, in some embodiments, each light spot is formed with multiple adjacent pixels on one scan line. In some embodiments, the light beam includes visible light, and in other embodiments, the light beam includes nonvisible light. The light beam may be scanned in one or two dimensions. For example, 3D imaging device 100 (FIG. 1) or 3D imaging device 900 (FIG. 9) may scan the light beam back and forth in only one dimension, or may scan the raster pattern 126 in two dimensions.

At 1020, positions of the at least two light spots with a field of view of an image sensor are detected. In some embodiments, the image sensor may be a CMOS image sensor. In other embodiments, the image sensor may be a charge coupled device. The image sensor may be phase locked with the scanning light source such that images capture one of the lights at a time. The image sensor is located a fixed distance from the scanning light source that scans the light spots at 1010. This fixed distance creates parallax in the view of the light spots as seen by the image sensor.

Frame dumps from the image sensor may be phase locked to the generation of the light spots. For example, the image sensor may be commanded to provide a frame of image data after each light spot is generated. Each resulting image frame includes one light spots. In some embodiments, the size of light spots may be controlled by the time between frame dumps. For example, light captured by the image sensor may include all pixels illuminated between frame dumps.

At 1030, distances to the at least two light spots are determined. The distances are determined using the positions of the light spots within the field of view of the image sensor as described above with reference to FIG. 4. In some embodiments, a centroid of the light spot is determined, and the centroid is used to determine the distance.

In some embodiments, a region of interest is located within the field of view of the image sensor based on the 3D data or on other image processing. The at least two light spots may be relocated to be within the region of interest so as to provide for a more detailed 3D image of the imaged object within the region of interest. For example, referring now to FIGS. 3, 6, and 7, surface 310 may be identified as a region of interest in the light spot sequence shown in FIG. 3, and the light spots may be relocated as shown in FIG. 6 or FIG. 7 to be within the region of interest.

FIG. 11 shows a mobile device in accordance with various embodiments of the present invention. Mobile device 1100 may be a hand held 3D imaging device with or without communications ability. For example, in some embodiments, mobile device 1100 may be a 3D imaging device with little or no other capabilities. Also for example, in some embodiments, mobile device 1100 may be a device usable for communications, including for example, a cellular phone, a smart phone, a personal digital assistant (PDA), a global positioning system (GPS) receiver, or the like. Further, mobile device 1100 may be connected to a larger network via a wireless (e.g., WiMax) or cellular connection, or this device can accept and/or transmit data messages or video content via an unregulated spectrum (e.g., WiFi) connection.

Mobile device 1100 includes 3D imaging device 1150 to create 3D images. 3D imaging device 1150 may be any of the 3D imaging devices described herein, including 3D imaging device 100 (FIG. 1) or 3D imaging device 900 (FIG. 9). 3D imaging device 1150 is shown including scanning mirror 116 and image sensor 180. Mobile device 1100 also includes many other types of circuitry; however, they are intentionally omitted from FIG. 11 for clarity.

Mobile device 1100 includes display 1110, keypad 1120, audio port 1102, control buttons 1104, card slot 1106, and audio/video (A/V) port 1108. None of these elements are essential. For example, mobile device 1100 may only include 3D imaging device 1150 without any of display 1110, keypad 1120, audio port 1102, control buttons 1104, card slot 1106, or A/V port 1108. Some embodiments include a subset of these elements. For example, an accessory projector product that includes 3D imaging capabilities may include 3D imaging device 900 (FIG. 9), control buttons 1104 and A/V port 1108.

Display 1110 may be any type of display. For example, in some embodiments, display 1110 includes a liquid crystal display (LCD) screen. Display 1110 may or may not always display the image captured by 3D imaging device 1150. For example, an accessory product may always display the captured image, whereas a mobile phone embodiment may capture an image while displaying different content on display 1110. Keypad 1120 may be a phone keypad or any other type of keypad.

A/V port 1108 accepts and/or transmits video and/or audio signals. For example, A/V port 1108 may be a digital port that accepts a cable suitable to carry digital audio and video data. Further, A/V port 1108 may include RCA jacks to accept or transmit composite inputs. Still further, A/V port 1108 may include a VGA connector to accept or transmit analog video signals. In some embodiments, mobile device 1100 may be tethered to an external signal source through A/V port 1108, and mobile device 1100 may project content accepted through A/V port 1108. In other embodiments, mobile device 1100 may be an originator of content, and A/V port 1108 is used to transmit content to a different device.

Audio port 1102 provides audio signals. For example, in some embodiments, mobile device 1100 is a 3D media recorder that can record and play audio and 3D video. In these embodiments, the video may be projected by 3D imaging device 1150 and the audio may be output at audio port 1102.

Mobile device 1100 also includes card slot 1106. In some embodiments, a memory card inserted in card slot 1106 may provide a source for audio to be output at audio port 1102 and/or video data to be projected by 3D imaging device 1150. In other embodiments, a memory card inserted in card slot 1106 may be used to store 3D image data captured by mobile device 1100. Card slot 1106 may receive any type of solid state memory device, including for example, Multimedia Memory Cards (MMCs), Memory Stick DUOS, secure digital (SD) memory cards, and Smart Media cards. The foregoing list is meant to be exemplary, and not exhaustive.

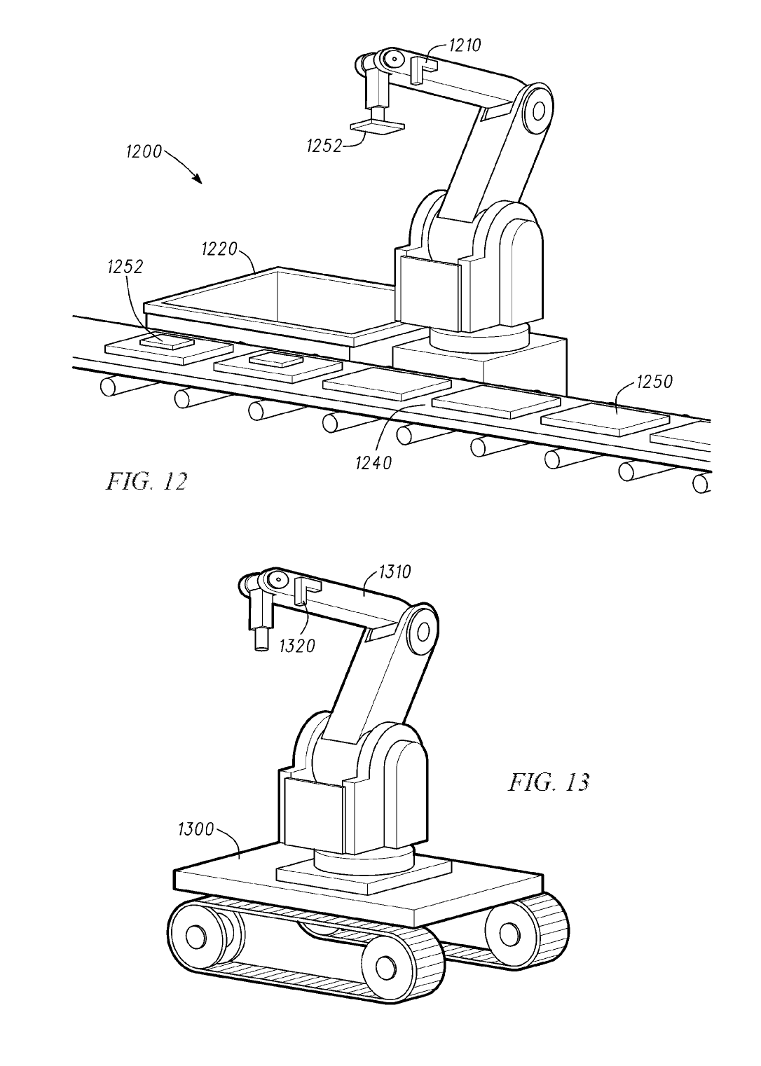

FIGS. 12 and 13 show robotic vision systems in accordance with various embodiments of the invention. The robotic system 1200 of FIG. 12 includes robotic arm 1230 and 3D imaging device 1210. 3D imaging device 1210 may be any 3D imaging device as described herein, including 3D imaging device 100 (FIG. 1) or 3D imaging device 900 (FIG. 9). In the example of FIG. 12, the robotic system is picking parts 1252 from parts bin 1220 and placing them on assemblies 1250 on assembly line 1240.

In some embodiments, 3D imaging device 1210 performs 3D imaging of parts within parts bin 1220 and then performs 3D imaging of assemblies 1250 while placing parts.

The robotic system 1300 of FIG. 13 includes a vehicular robot with robotic arm 1310 and 3D imaging device 1320. 3D imaging device 1320 may be any 3D imaging device as described herein, including 3D imaging device 100 (FIG. 1) or 3D imaging device 900 (FIG. 9). In the example of FIG. 13, the robotic system is able to maneuver based on its perceived 3D environment.

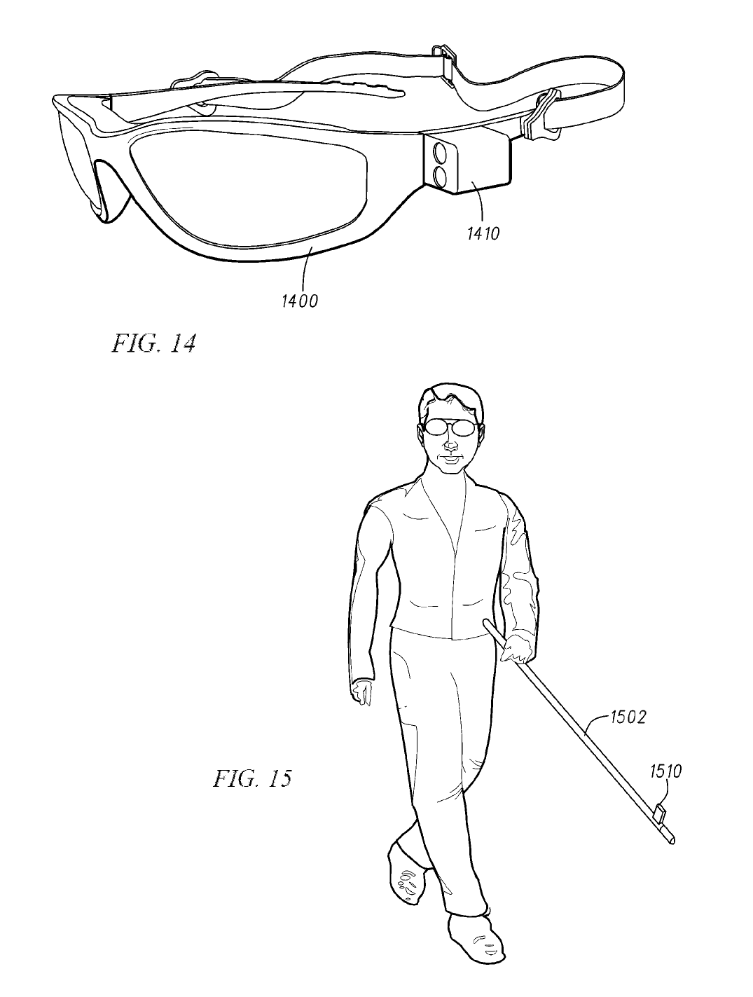

FIG. 14 shows a wearable 3D imaging system in accordance with various embodiments of the invention. In the example of FIG. 14, the wearable 3D imaging system 1400 is in the form of eyeglasses, but this is not a limitation of the present invention. For example, the wearable 3D imaging system may be a hat, headgear, worn on the arm or wrist, or be incorporated in clothing. The wearable 3D imaging system 1400 may take any form without departing from the scope of the present invention.

Wearable 3D imaging system 1400 includes 3D imaging device 1410. 3D imaging device 1410 may be any 3D imaging device as described herein, including 3D imaging device 100 (FIG. 1) or 3D imaging device 900 (FIG. 9). In some embodiments, wearable 3D imaging system 1400 provides feedback to the user that is wearing the system. For example, a head up display may be incorporate to overlay 3D images with data to create an augmented reality. Further, tactile feedback may be incorporated in the wearable 3D imaging device to provide interaction with the user.

FIG. 15 shows a cane with a 3D imaging system in accordance with various embodiments of the invention. Cane 1502 includes 3D imaging device 1510. 3D imaging device 1510 may be any 3D imaging device as described herein, including 3D imaging device 100 (FIG. 1) or 3D imaging device 900 (FIG. 9). In the example of FIG. 15, the cane is able to take 3D images of the surrounding environment. For example, cane 1500 may be able to detect obstructions (such as a curb or fence) in the path of the person holding the cane.

Feedback mechanisms may also be incorporated in the cane to provide interaction with the user. For example, tactile feedback may be provided through the handle. Also for example, audio feedback may be provided. Any type of user interface may be incorporated in cane 1500 without departing from the scope of the present invention.

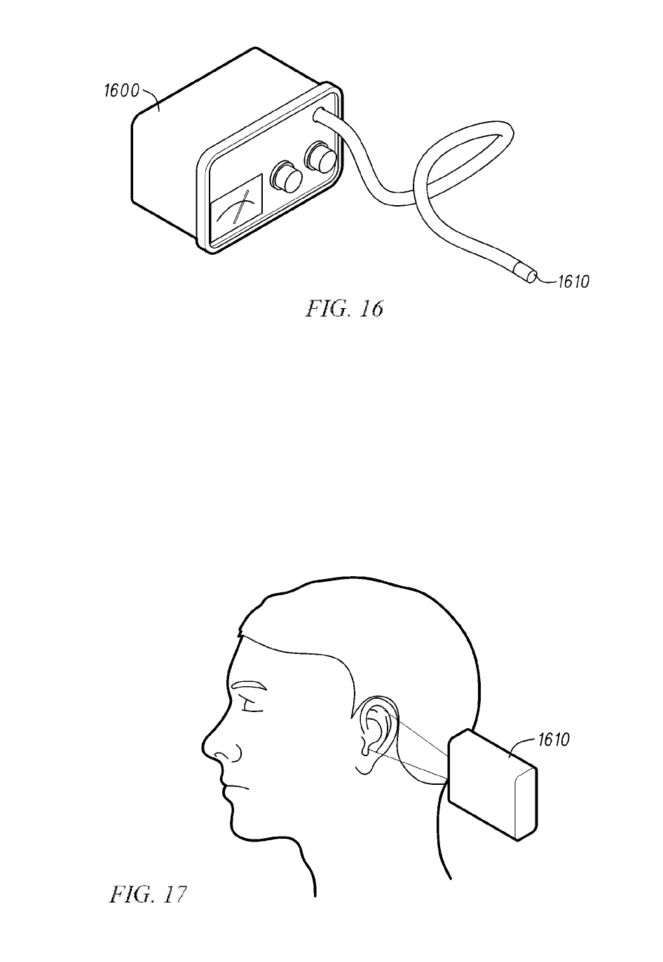

FIGS. 16 and 17 show medical systems with 3D imaging devices in accordance with various embodiments of the present invention. FIG. 16 shows medical system 1600 with 3D imaging device 1610 at the end of a flexible member. 3D imaging device 1610 may be any 3D imaging device as described herein, including 3D imaging device 100 (FIG. 1) or 3D imaging device 900 (FIG. 9). In the example of FIG. 16, medical equipment 1600 may be useful for any medical purpose, including oncology, laparoscopy, gastroenterology, or the like.

Medical equipment 1600 may be used for any purpose without departing from the scope of the present invention. For example, FIG. 17 shows 3D imaging device 1610 taking a 3D image of an ear. This may be useful for fitting a hearing aid, or for diagnosing problems in the ear canal. Because 3D imaging device 1610 can be made very small, imaging of the ear canal's interior is made possible.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. An imaging device comprising:
a scanning light source to project light on an object;
an image sensor to detect a position within a field of view of light reflected from the object; and
a computation component to determine a distance to the object based at least in part on the position within the field of view.

2. The imaging device of claim 1 wherein the scanning light source comprises a laser light source and a scanning mirror.

3. The imaging device of claim 2 wherein the laser light source produces visible light.

4. The imaging device of claim 2 wherein the laser light source produces light in a nonvisible spectrum.

5. The imaging device of claim 1 wherein the image sensor comprises a CMOS image sensor.

6. The imaging device of claim 1 wherein the image sensor comprises a charge coupled device.

7. An imaging device comprising:
a scanning light source to project light on different points of an object;
a light detection component to detect light reflected from the different points of the object, the light detection component located an offset distance from the scanning light source; and
a computation component, responsive to the light detection component, to determine a distance to the different points of the object based at least in part on the offset distance.

8. The imaging device of claim 7 wherein the scanning light source comprises a laser light source and a scanning mirror.

9. The imaging device of claim 8 wherein the laser light source produces visible light.

10. The imaging device of claim 8 wherein the laser light source produces light in a nonvisible spectrum.

11. The imaging device of claim 10 wherein the laser light source produces infrared light.

12. The imaging device of claim 7 wherein the light detection component comprises a CMOS image sensor.

13. The imaging device of claim 7 wherein the light detection component comprises a charge coupled device.

14. The imaging device of claim 7 wherein the computation component determines a centroid of reflected light within a field of view of the light detection component.

15. The imaging device of claim 7 wherein the light detection component includes a resolution of one bit per pixel.

16. The imaging device of claim 7 wherein the light detection component includes a resolution of more than one bit per pixel.

17. The imaging device of claim 7 wherein the scanning light source projects visible and nonvisible light, and the light detection component detects at least nonvisible light.

18. An electronic vision system comprising:
a laser light source to produce a laser beam;
a scanning mirror to reflect the laser beam in a raster pattern;
an image sensor offset from the scanning mirror, the image sensor to determine positions of reflected light in a field of view of the image sensor; and
a computation component to determine distances to reflector surfaces based at least in part on the positions of reflected light in the field of view.

19. The electronic vision system of claim 18 wherein the laser light source produces an infrared laser beam and the image sensor senses infrared light.

20. The electronic vision system of claim 19 wherein the image sensor also senses visible light.

21. The electronic vision system of claim 20 wherein the computation component produces information representing a three dimensional color image.

22. The electronic vision system of claim 18 further comprising a robotic arm to which the scanning mirror and image sensor are affixed.

23. A method comprising:
scanning a light beam to create at least two light spots on an object at different times;
detecting positions of the at least two light spots in a field of view of an image sensor; and
determining distances to the at least two light spots using the positions of the at least two light spots in the field of view of the image sensor.

24. The method of claim 23 wherein scanning a light beam comprises scanning an infrared laser beam.

25. The method of claim 23 wherein scanning a light beam comprises scanning a visible laser beam.

26. The method of claim 23 wherein scanning comprises scanning in one dimension.

27. The method of claim 23 wherein scanning comprises scanning in two dimensions.

28. The method of claim 23 further comprising determining a region of interest and modifying locations of the at least two light spots to be within the region of interest.

29. The method of claim 23 further comprising phase locking creation of the at least two light spots with a frame dump of the image sensor.
